(19) United States
(12) Patent Application Publication
(10) Pub. No.: US 2018/0230646 A1
(43) Pub. Date: Aug. 16, 2018

(54) METHOD FOR PRODUCING A FLOOR COVERING (INCLUDING CARPET AND CARPET TILE) WITH POSITIVE DEFINED RECYCLED CONTENT

(71) Applicant: DESSO B.V., Waalwijk (NL)

(72) Inventors: Henricus Martinus Marie Koppers, Tiel (NL); Marinus Gerardus Maria Van Oers, Hoeven (NL); Ludwig Maria Gerardus Irma Cammaert, Berkel-Enschot (NL)

(21) Appl. No.: 15/513,802

(22) PCT Filed: Sep. 21, 2015
(86) PCT No.: PCT/NL15/50655

§ 371 Date: Mar. 23, 2017

(30) Foreign Application Priority Data
Sep. 24, 2014 (NL) 2013521

(51) Int. Cl. D06N 7/00; C02F 5/06

(52) U.S. Cl. CPC D06N 7/0071; B29L 2031/7322; C02F 5/06

(57) ABSTRACT

The present invention relates to a method for producing floor covering (including carpet and carpet tiles) with recycled content, comprising the steps of gaining CaCO₃ from ground or surface water during a softening process by adding a grain to the water, grafting the CaCO₃ to the grain, adding the CaCO₃ to the (fluid) backing material for a carpet or carpet tile (precoat or heavy coating layer), using the thus obtained backing material in a carpet or carpet tile manufacturing process, wherein the grain comprises essentially CaCO₃.

The present invention relates to a method for producing floor covering (including carpet and carpet tile) with positive defined recycled content. In particular, the invention relates to the use of CaCO₃ that is a waste product from ground- or surfacewater purification process.

Carpet and carpet tiles comprise a top layer of yarns, in general tufted onto a cloth of web, which is provided with at least one, but in general multiple backing layers. These layers protect the top layer from wear that would be caused when the top layer was applied directly onto the floor, provide a “body” (right stiffness/flexibility), weight to the tile as well as ensuring dimensional stability.

Although the above description is focussed on carpets, the process can be used for other floor coverings as well, eg. VCT, Turf, Linoleum etc.

Several materials can be used for the backing, ranging from classic bitumen, PVC, EVA, PVB, SBR, PET to more environmental friendly polyolefin solutions that can be recycled. Herein, it is common practice to add CaCO₃ as a stabiliser/filler material, in as well the precoat as well as the heavy coating layer.

According to the state of the art, the CaCO₃ is purchased for that purpose from manufacturers who are able to provide the CaCO₃, typically mined, in a quality standard that is consistent enough for use in the carpet or carpet tile backing. However, it has now become an aim to avoid mining of natural sources and to produce more environmental friendly, and for that reason an alternative to the existing natural sources of raw materials was searched for.

CaCO₃ is a material that is removed from ground- or surfacewater when softening, said water for consumption purposes. Also, the presence of low CaCO₃ content (also referred to a chalk) is positive for several apparatus such as washing machines and coffee makers, related to less lime scale, resulting in lower use of electricity and a longer lifespan. However, CaCO₃ is not gained in a pure form from the softening process.

Besides metals like iron and manganese, the residue comprises high percentages of sand (SiO₂) that was used as a grain material, which makes it useless for the production of carpet and carpet tiles, since the sand has a negative influence on the die cutting knifes or ultra sonic knives for cutting the carpet into tiles.

It is therefore a goal of the present invention to provide an alternative way for gaining CaCO₃ as a waste material, wherein the material is suitable for use for flooring and in particular carpet and carpet tile manufacturing, in particular without the need of further purification.

The invention thereto proposes a method for producing floor covering, preferably a carpet or carpet tile with recycled content, comprising the steps of gaining CaCO₃ from waste water by gaining CaCO₃ from the waste water during a softening process by adding a grain to the water, grafting the CaCO₃ to the grain and adding the CaCO₃ to the flooring material, in particular to the (fluid) backing material for a carpet tile and using the thus obtained backing material in a floor covering, preferably a carpet tile manufacturing process, wherein the grain comprises essentially CaCO₃.

By using CaCO₃ instead of sand (SiO₂) as a graining material, a purer final result is obtained, that can be used without the need of further purification as an addition for the flooring material, preferably carpet and carpet tiles. This enables operations of the manufacturing process, and saves the die cutting knives or ultra sonic cutting knives used for producing the flooring material, preferably carpet and carpet tiles. In a further embodiment, the grain with grafted CaCO₃ is grounded to a predetermined particle size and particle size distribution before it is used as a backing material in a flooring material, in a floorcovering manufacturing process as an extra step.

Realising a predetermined distribution enables the production of a high quality carpet backing. One possible distribution that has proven to give good results is a distribution that comprises a D10=0-50 μm, D50=250-300 μm, D90=500-550 μm.

The process of grafting CaCO₃ can be speeded up by adding NaOH or Ca(HCO₃)₂ into the waste water. This leads to one of the following reactions:

2NaOH+Ca(HCO₃)₂→CaCO₃ (sediment)+Na₂CO₂+H₂O

or:

Ca(OH)₂+Ca(HCO₃)→2CaCO₃ (sediment)+2H₂O.

The method according to the invention in particular relates to a process wherein the grain comprises 90% or more CaCO₃. This leads to an end result wherein the final purity of the grafted CaCO₃ is even higher than 90%, which is very well usable for use in a carpet backing. In particular, the percentage of SiO₂ is lower than 0.5%. In the process according to the present invention, the CaCO₃ is grafted onto the grain until a diameter between 1 and 3 mm is obtained. Then the thus obtained grain is mould to a powder that is suitable for use in carpet backings (precoat and heavy coating layer). Therein the weight percentage of the CaCO₃ in the precoat is at least 12% and in the heavy coat is at least 40%.

1. A method for producing a floor covering, in particular a carpet and carpet tile, with recycled content, comprising the steps of:
gaining CaCO₃ from ground or surface water by:
Gaining CaCO₃ from the ground or surface water during a softening process by:
Adding a grain to the water;
Grafting the CaCO₃ to the grain;
adding the CaCO₃ to a floor covering raw material, in particular a (fluid) backing (precoat and/or heavy coating) material for a carpet or carpet tile;
using the thus obtained material in a floor covering manufacturing process;
wherein the grain comprises essentially CaCO₃.

2. The method according to claim 1, wherein the grain with grafted CaCO₃ is grounded to a predetermined particle size and particle size distribution before it is used as a backing material in the floor covering manufacturing process.

3. The method according to claim 1, wherein NaOH or Ca(HCO₃)₂ is used as an aid for speeding up the process.

4. The method according to claim 1, wherein the grain comprises 90% or more CaCO3.

5. The method according to claim 1, wherein the CaCO₃ is grafted onto the grain until a diameter between 1 and 3 mm is obtained.

6. The method according to claim 1, wherein the percentage of SiO₂ is lower than 0.5%.

7. The method according to claim 1, wherein the weight percentage of the CaCO₃ in the precoat is at least 12% and in the heavy coat is at least 40%.
